(19) United States
(12) Patent Application Publication
(10) Pub. No.: US 2010/0229140 A1
(43) Pub. Date: Sep. 9, 2010

(54) METHOD AND SYSTEM FOR ADAPTING A CIRCUIT LAYOUT TO A PREDEFINED GRID

(75) Inventors: Christinus Werner Hubertus Strolenberg, Nederwetten (NL); Jozefus Godefridus Gerardus Pancratius Van Gisbergen, Hilvarenbeek (NL); Yulian Pogerov, Qyriat-Biaklik (IL)

Correspondence Address: THORNE & HALAJIAN, LLP, 111 WEST MAIN STREET, BAY SHORE, NY, 11706, US

(73) Assignee: SAGANTEC ISRAEL LTD, TIRAT CARMEL (IL)

(21) Appl. No.: 12/376,427

(22) PCT Filed: Jul. 20, 2007
(86) PCT No.: PCT/EP2007/057508

§ 371 Date: Apr. 5, 2010

(30) Foreign Application Priority Data
Aug. 4, 2006 (EP) 06118473.5

(51) Int. Cl. G06F 17/50

(52) U.S. Cl. 716/9; 716/10

(57) ABSTRACT

A method for adapting objects of a circuit layout to a predefined grid, wherein the objects are a representation of an integrated circuit, each object being defined by elements including a reference element. A reference element is selected which is unaligned to the predefined grid, and a gridline is selected from the predefined grid. A grid-constraint is generated which is subsequently added to a set of constraints associated with the circuit layout. The set of constraints includes design-rule constraints for applying a design rule to groups of objects of the circuit layout. The objects of the circuit layout are adapted to substantially comply with the set of constraints. Reference elements unaligned to the predefined grid are gridded while compliance of the circuit layout with the design rules is maintained.

### FIELD OF THE INVENTION

The invention relates to a method for adapting an circuit layout to a predefined grid.

The invention further relates to a system and to a computer program product.

### BACKGROUND OF THE INVENTION

Integrated circuit layouts generally comprise objects wherein a set of objects is a representation of an integrated circuit. The objects in an integrated circuit layout typically must comply with a set of rules, so called design rules. Design rules are specific to a particular semiconductor manufacturing process. A set of design rules specifies certain geometric and connectivity restrictions between objects of the integrated circuit layout to account for variability in semiconductor manufacturing processes. Different manufacturing processes typically comprise different sets of design rules. Compliance of the objects to a specific set of design rules associated with a specific manufacturing process ensures that the integrated circuit layout can be manufactured using the specific manufacturing process.

To check compliance of an integrated circuit layout with a set of design rules and to adapt (in a case of non-compliance) the integrated circuit layout to substantially comply to the set of design rules, layout processing systems are used. The known layout processing systems scan the objects of the integrated circuit layout, and search for non-compliances of a design rule. When non-compliance of a set of objects to a design rule is found, a design-rule-constraint is generated by the layout processing system and added to a set of constraints associated with the integrated circuit layout. The design-rule-constraint is a representation of a required relationship prescribed in the design rule between a sub-set of objects such that the sub-set of objects complies with the design rule. This representation often is a mathematical representation of the design rule applied to the sub-set of objects. When all objects of the integrated circuit layout have been scanned and when all design-rule-constraints from a complete the set of constraints is complete, the layout processing system will solve the set of constraints. The solution found by the layout processing system provides a set of instructions indicating how to adapt the integrated circuit layout to obtain compliance or to obtain best compliance with the set of design rules.

Typically, patterning tools, for example, optical lithography tools or electron beam lithography tools are used to transfer the integrated circuit layout into a silicon pattern on a wafer. Optical patterning tools generally image a transmission mask comprising the integrated circuit layout on the wafer. This transmission mask is typically manufactured using an electron beam or laser beam lithography tool. The use of electron beam or laser beam lithography tools generally require the actual physical design of the objects of the integrated circuit layout to be aligned to a predefined grid constituted of a matrix of allowable x and y discrete gridlines. Different methods are known which ensure that the objects are located on the predefined grid. For example, grid-snapping in which the objects which are not located on the predefined grid snap to the nearest gridlines of the predefined grid. Or, for example, a method in which the problem of moving objects to a grid-location is solved using a branch and bound method.

A drawback of the known methods is that the layout of the integrated circuit layout after gridding may not be correct.

### SUMMARY OF THE INVENTION

It is an object of the invention to provide an improved method for gridding.

According to a first aspect of the invention the object is achieved with a method for adapting an circuit layout to a predefined grid, the circuit layout comprising objects being a representation of an integrated circuit, each object being defined by elements including a reference element, the method comprising the steps of:
selecting a reference element being unaligned to a predefined grid,
selecting a gridline from the predefined grid,
generating a grid-constraint for constraining the selected reference element to the selected gridline, the grid-constraint being a representation of a required relationship between the selected reference element and the selected gridline,
adding the grid-constraint to a set of constraints associated with the circuit layout, the set of constraints comprising design-rule-constraints for applying a design rule to groups of objects of the circuit layout,
adapting the objects of the circuit layout to substantially comply with the set of constraints.

The effect of the method in accordance with the invention is that a grid-constraint is generated and added to the set of constraints. Subsequently, the objects of the circuit layout are adapted to substantially comply with the set of constraints. Because the set of constraints in the method according to the invention comprises both the grid-constraint and the design-rule-constraints, the step of adapting the circuit layout results in the selected reference element to be on grid while the remainder of the design maintains substantially compliant with the design rules.

In the known grid-snapping method the objects which are not located on the predefined grid will move to the nearest gridline of the predefined grid. However, this move of the non-gridded object may violate design rules which may result in an integrated circuit which will not function properly or which may not function at all. In the method according to the invention, the required move of the non-gridded object to the selected gridline is translated into a grid-constraint and added to the set of constraints associated with the circuit layout. Adapting the objects of the circuit layout according to the set of constraints which includes the grid-constraint ensures that the non-gridded object is moved to the selected gridline while substantial compliance with the design rules is maintained.

The objects of the circuit layout typically are polygons which are defined by elements. The object may be defined by boundaries of the polygon, in which case the elements defining the object are the boundaries and one of the boundaries is the reference element. The object may alternatively be defined by a path having a specific width, in which case the elements defining the object are the path and the width, and typically the path of the object is used as the reference element. The object may also be defined by the corners of the polygon, in which case the elements defining the object are the corners of the polygon, one of the corners being the reference element.

The adapting of the object of the circuit layout typically includes solving the set of constraints to generate instructions for adapting the circuit layout to substantially comply with the adapted set of constraints. Adapting the circuit layout according to the instruction may result in moving the objects within the circuit layout and/or may result in reshaping the objects within the circuit layout.

The grid-constraint constraining the reference element to the gridline is a local constraint which substantially affects the circuit layout typically locally. The circuit layout preferably is already substantially complying with the set of design rules and the layout processing system already has solved an initial set of constraints representing the set of design rules. Because of the local nature of the grid-constraint it is experienced that a major part of the solution related to the initial set of constraints is still valid when solving the set of constraints comprising the grid-constraint. This will typically lead to a relatively short processing time for adapting the objects to substantially comply with the set of constraints which comprises the added grid-constraint.

The method according to the invention can advantageously be combined with known layout processing methods performed by known layout processing tools. Typically the known layout processing tools must be adapted to be able to perform the method according to the invention. However, this combination of the method according to the invention and known layout processing methods enable a further reduction of the processing time. During the known layout processing methods the objects of the integrated circuit layout must be scanned after which compliance with the set of design-rules is checked. When combining the method according to the invention with the known layout processing methods, the scanning of objects can now both be used for checking compliance with the set of design rules and for gridding the circuit layout on the predefined grid, thus reducing the processing time.

The integrated circuit may be a representation of a miniaturized electrical circuit, also commonly known as a chip, or may be a representation of a part of the chip. Alternatively, the integrated circuit may be a representation of a miniaturized construction, also commonly known as nanostructures, comprising, for example, mechanical nanostructures, magnetic nanostructures, chemical nanostructures and biological nanostructures.

In an embodiment of the method, the steps of the method are applied iteratively by in each iteration selecting a further reference element being unaligned to the predefined grid. A benefit of this embodiment is that each reference element or further reference element which is unaligned to the grid is sequentially gridded. The method according to the invention selects the reference element or the further reference element. After generating a grid-constraint and adding the grid-constraint to the set of constraints, the circuit layout is adapted to substantially comply with the set of constraints. Because only a single grid-constraint is added to the set of constraints, the increase of complexity of the set of constraints due to the adding of the grid-constraint is limited and as such the solution of the set of constraints will be close to the solution to the initial set of constraints representing the set of design rules. If the circuit layout is already substantially complying with the set of design rules it is experienced that a solution to the adapted set of constraints will be found relatively quickly, because the difference between the set of constraints and the initial set of constraints is relatively small. By sequentially solving the set of constraints for each selected further reference element, the problem of gridding the circuit layout is split in a number of individual gridding steps, one for each non-gridded reference element, wherein a solution to each of the gridding steps is experienced to be found relatively quickly.

In an embodiment of the method, the method further comprises a step of: securing a location of the reference element gridded in a previous iteration before adapting the objects of the circuit layout by replacing the grid-constraint of the gridded reference element in the set of constraints by a priority-constraint for securing the location of the gridded reference element, the priority-constraint being a representation of a required fixation of the gridded reference element to the selected gridline. A benefit of this embodiment is that in an iterative process the selected reference element which has been aligned to the grid during a first step in the iterative process is fixed before adapting the objects of the circuit layout in a further iteration step of the method. This results in a limited number of iteration steps to obtain an circuit layout in which substantially all reference elements are aligned to the grid.

The known branch and bound method for solving a gridding problem is a so called NP-complete problem for which generally an infinite number of iteration steps is required to find an exact solution to the problem. The method according to the invention sequentially grids the reference elements of the circuit layout which are unaligned to the grid. During each iterative gridding step, a selected reference element or a further selected reference element is gridded. By securing the location of the reference element gridded in the previous iteration step, the method according to the invention requires a finite number of iteration steps for gridding reference elements of the circuit layout which are unaligned to the predefined grid.

In an embodiment of the method, the priority-constraint comprises a priority-value representing a level of importance of the required fixation of the gridded reference element. The priority-value may vary for different reference elements to, for example, generate different levels of fixation and as such represent the required fixation in different levels of fixation of the gridded reference element. The different levels of fixation, for example, depend on the importance of the fixation of the reference element to the gridded position. The fixation of the reference elements having a relatively high priority-value, for example, has priority over the fixation of the reference elements having a relatively low priority-value. This increases the flexibility to find a solution to the set of constraints such that the selected reference element can be gridded while the objects of the circuit layout substantially comply with the design rules.

In an embodiment of the method, the step of selecting a gridline comprises selecting a pair of gridlines arranged on opposite sides of the selected reference element or the selected further reference element, wherein the grid-constraint associated with the selected reference element or the selected further reference element comprises a disjunction-constraint for constraining the selected reference element or the selected further reference element to either one of the gridlines in the selected pair of gridlines. A benefit of this embodiment of the method is that it increases the possibility that the objects can be adapted to substantially comply with the set of constraints, because the selected reference element or the selected further reference element may be moved to either one of the selected pair of gridlines. Typically the circuit layout occupies an area on a silicon wafer, a so called footprint. Within this footprint generally smaller un-used areas may be identified, so call redundant areas. These redundant areas in the circuit layout are used for shifting the objects of the circuit layout to enable the selected reference element or the further selected reference element to be gridded while the compliance of the circuit layout with the design rules is maintained. However, circuit layouts for which, for example, the total footprint has been minimized (while complying with the design rules), typically have a limited number of redundant areas. Selecting the pair of gridlines on opposite sides of the selected reference element or of the further selected reference element instead of selecting a single gridline enables the use of redundant areas on either side of the selected reference element or the selected further reference element which significantly increases the possibility to find a solution to adapt the objects to substantially comply with the set of constraints.

In an embodiment of the method, the step of adapting the objects of the circuit layout comprising solving the set of constraints to generate instructions for adapting the circuit layout, wherein the method further comprises a step of: splitting the disjunction-constraint in a first and a second grid-constraint, and solving the set of constraints using the first grid-constraint, the first grid-constraint constraining the selected reference element to a first gridline of the selected pair of gridlines and the second grid-constraint constraining the selected reference element to a second gridline of the selected pair of gridlines, and wherein the second grid-constraint is only used for solving the set of constraints when the set of constraints cannot be solved using the first grid-constraint. A benefit of this embodiment is that the method according to the invention splits the disjunction-constraint into a first and a second grid-constraints, each not being disjunct. The method according to the invention selects the first grid-constraint and tries to solve the set of constraints using the first grid-constraint. If a solution is found using the first grid-constraint, the instructions resulting from the found solution are used to adapt the objects of the circuit layout. If no solution is found using the first grid-constraint, the second grid-constraint is used for solving the set of constraints. By splitting the disjunction-constraint into the first and the second grid-constraints both not being disjunct, the number of solutions for solving the disjunction-constraint is limited and the time required to find a solution to the disjunction-constraint is reduced.

In an embodiment of the method, the step of selecting a gridline comprises selecting a pair of intersecting gridlines defining a grid-point, wherein the step of generating a grid-constraint comprises generating a grid-point-constraint constraining the selected reference element or the selected further reference element to the selected pair of intersecting gridlines. A benefit of this embodiment is that the method can be performed in two-dimensions.

In an embodiment of the method, the step of selecting the reference element or the further reference element comprises scanning the circuit layout in a scan-direction defined by scanning from an edge of the circuit layout away from the edge along a grid axis and selecting a first reference element or a first further reference element from the edge being unaligned to the predefined grid. The method typically moves the selected reference element or the selected further reference element, and as such also the associated object, within the circuit layout. Generally the design rules are arranged to fit on the predefined grid, for example, a design rule defining a minimum distance between two objects, or a design rule defining a pitch between a plurality of objects generally are arranged to fit on the predefined grid on which the circuit layout must be gridded. An example of design rules fitting the predefined grid is, for example, when a distance between two grid-lines in the predefined grid is equal to a sum of the minimum distance between two objects and the minimum width of an object. Furthermore, a specific object can only move for gridding when the footprint of the circuit layout contains redundancies which can be used for moving objects of the circuit layout without violating the design rules. If the specific object moves in the direction of the scan direction, intermediate objects of the circuit layout which are located between the specific object and the redundant area will generally move together with the specific object to ensure compliance with the design rules. Due to the fact that the design rules are generally arranged to fit on the predefined grid, many of the intermediate objects will be gridded automatically together with the specific object, resulting in a substantial decrease of the processing time of the method.

In a preferred embodiment of the method, the method further comprises a step of: securing all reference elements being aligned to the predefined grid and being located between the edge of the circuit layout and the selected reference element or the selected further reference element along the scan-direction before performing the step of adapting the objects of the circuit layout to substantially comply with the set of constraints. The effect of this embodiment is that the gridding is performed in an incremental manner in which, starting from the edge of the circuit layout, the reference elements unaligned to the grid are sequentially gridded in the scan-direction. Because the reference elements which have already been aligned to the grid in a previous iteration step are secured before the next reference element is aligned to the grid, the compliance of the circuit layout to the grid increases with every iteration step.

According to a second aspect of the invention, the object is achieved with a system as claimed in claim 10. According to a third aspect of the invention, the object is achieved with a computer program product as claimed in claim 11.

### BRIEF DESCRIPTION OF THE DRAWINGS

These and other aspects of the invention are apparent from and will be elucidated with reference to the embodiments described hereinafter.

In the drawings:

FIG. 1 shows a flowchart of a method according to the invention,

FIG. 2 shows a schematic representation of the system according to the invention,

FIGS. 3A, 3B, 3C and 3D show several steps performed by the method according to the invention when gridding two objects of the circuit layout,

FIGS. 4A and 4B show steps of the method when the reference element is a path, and

FIGS. 5A and 5B show steps of the method when the reference element is a corner, and

FIGS. 6A, 6B and 6C show several steps in the method for gridding a plurality of objects forming a grating.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF THE EMBODIMENTS

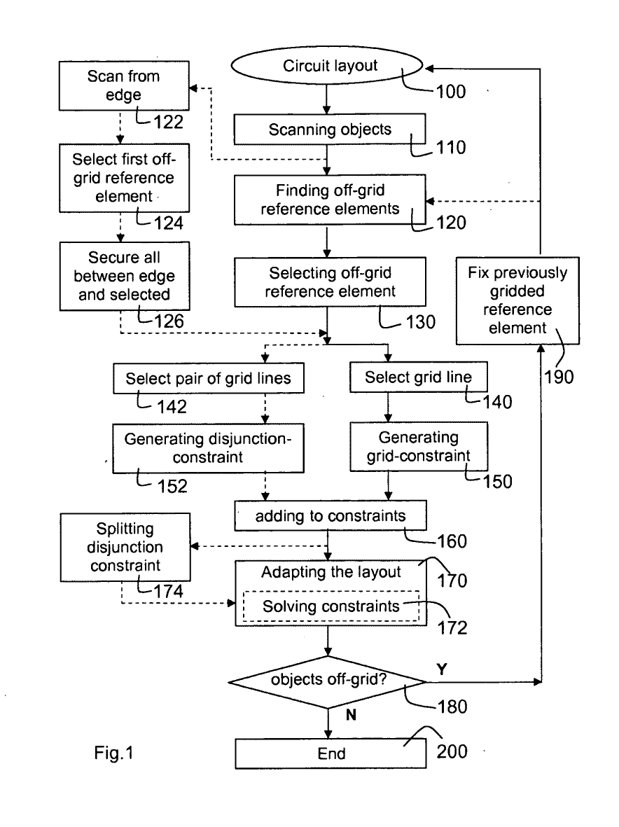

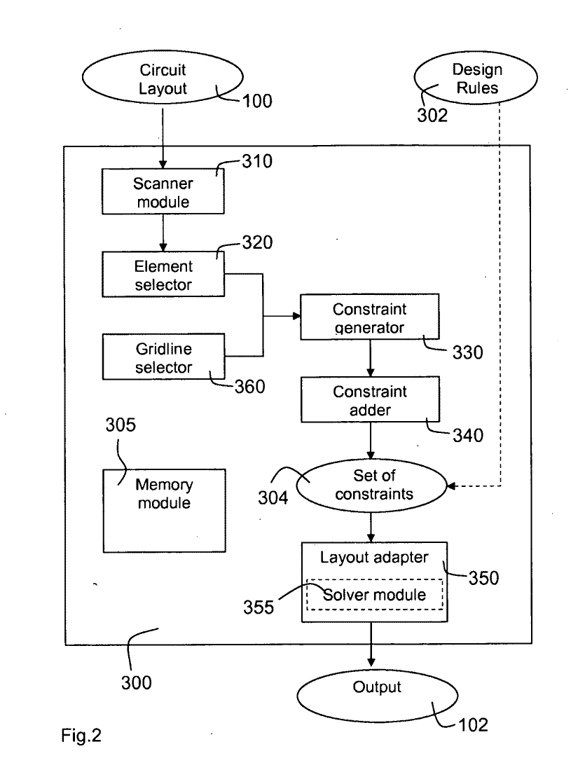

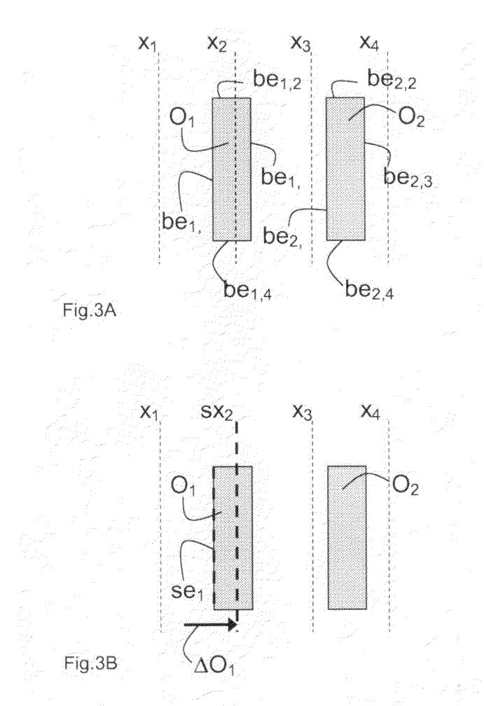

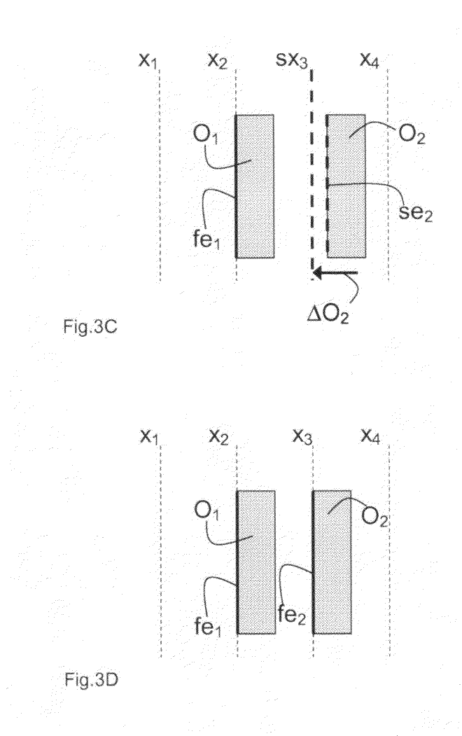

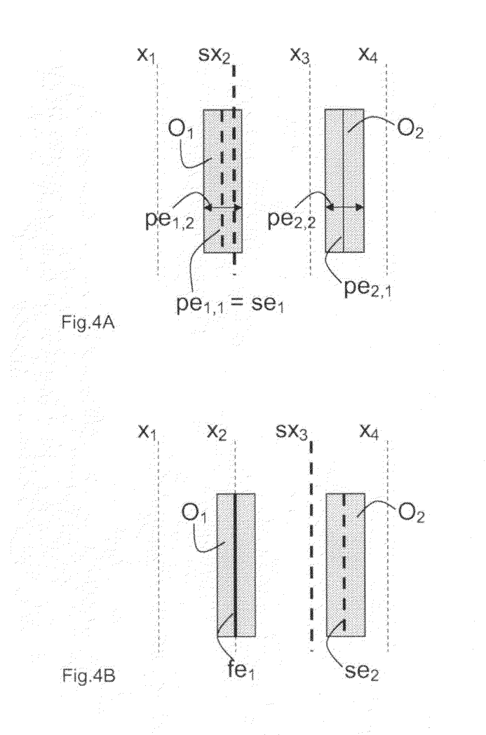

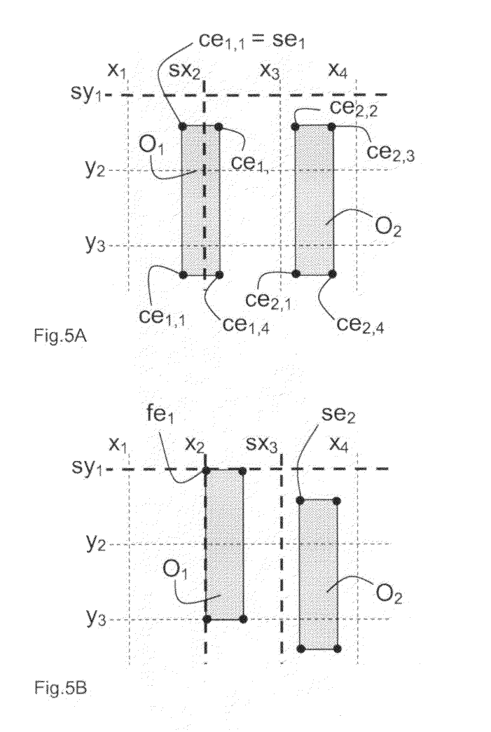

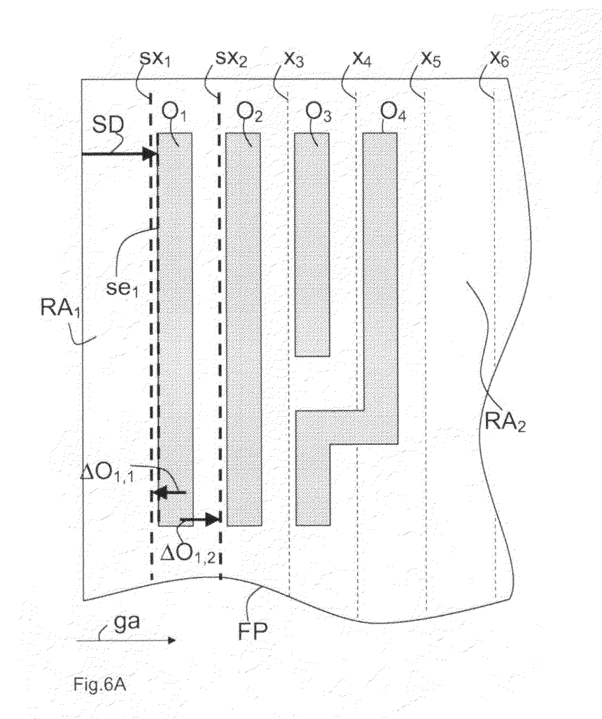

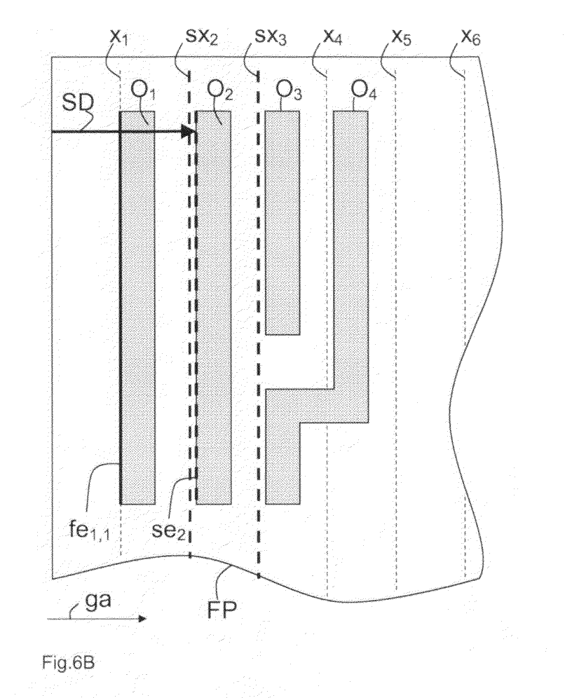

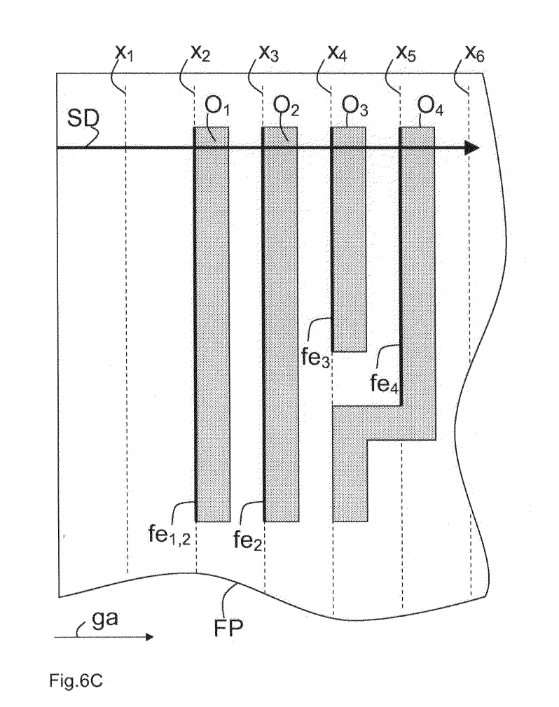

FIG. 1 shows a flowchart of a method according to the invention. The method according to the invention uses an circuit layout 100 and adapts the circuit layout 100 to substantially comply with a set of constraints 304 (see FIG. 2). The circuit layout 100 comprises objects O1, O2, O3, O4 (see FIGS. 3, 4, 5 and 6) which are a representation of an integrated circuit. The integrated circuit may be a representation of a miniaturized electrical circuit (not shown), also commonly known as a chip, or may be a representation of a part of the chip. Alternatively, the integrated circuit may be a representation of a miniaturized construction, also commonly known as nanostructures (not shown), comprising, for example, mechanical nanostructures, magnetic nanostructures, chemical nanostructures and biological nanostructures. The objects O1, O2, O3, O4 typically are polygons which are defined by elements be_{n,m}, pe_{n,m}, ce_{n,m} (n indicating a specific object O1, O2, O3, O4 and m indicating an element of the specific object O1, O2, O3, O4) including a reference element. The object O1, O2, O3, O4 may be defined by boundaries be_{n,m} (see FIGS. 3 and 6) of the polygon, in which case the elements be_{n,m} defining the object O1, O2, O3, O4 are the boundaries be_{n,m} and one of the boundaries be_{n,m} is the reference element. The object O1, O2, O3, O4 may alternatively be defined by a path pe_{n,1} having a specific width pe_{n,2}, (see FIG. 4) in which case the elements defining the object O1, O2, O3, O4 are the path pe_{n,1} and the width pe_{n,2}, where typically the path pe_{n,1} of the object O1, O2, O3, O4 is used as the reference element. The object O1, O2, O3, O4 may also be defined by the corners ce_{n,m} of the polygon (see FIG. 5), in which case the elements defining the object O1, O2, O3, O4 are the corners ce_{n,m} of the polygon, one of the corners ce_{n,m} being the reference element. The reference element of the object O1, O2, O3, O4 must be aligned to a predefined grid constituted of a matrix of allowable discrete gridlines xᵢ, yᵢ (i indicating a specific gridline, and xᵢ indicating a specific gridline perpendicular to an x-axis of the predefined grid, and yᵢ indicating a specific gridline perpendicular to an y-axis of the predefined grid). The predefined grid may be a one-dimensional, two-dimensional, or three-dimensional grid, and may preferably be constituted of an orthogonal grid having equidistant gridlines xᵢ, yᵢ. Each grid orientation comprises a grid axis arranged substantially perpendicular to the associated gridlines xᵢ, yᵢ.

The method according to the invention scans all objects O1, O2, O3, O4 of the circuit layout 100 and identifies the elements be_{n,m}, pe_{n,m}, ce_{n,m} and reference elements of each one of the objects O1, O2, O3, O4 in a step of scanning objects 110. Subsequently the method according to the invention searches the identified reference elements for reference elements which are off-grid during a step of finding off-grid reference elements 120. One of the off-grid reference elements is selected to be a selected reference element seₙ (n indicating the specific object O1, O2, O3, O4 associated with the selected reference element) during a step of selecting off-grid reference element 130. Next, a gridline xᵢ, yᵢ is selected from the predefined grid during a step of selecting gridline 140. The selected gridline sxᵢ, syᵢ may, for example, be located near the selected reference element seₙ such that the gridding of the selected reference element seₙ can be done with only minor adaptations to the circuit layout 100. The method of gridding generates a grid-constraint during a step of generating grid-constraint 150. The grid-constraint is a representation of a required relationship between the selected reference element seₙ and the selected gridline sxᵢ, syᵢ. The generated grid-constraint is added to the set of constraints 304 (see FIG. 2) associated with the circuit layout 100 during a step of adding to constraints 160. The set of constraints 304 associated with the circuit layout 100 comprises design-rule-constraints being a representation of a required relationship prescribed in a design rule between a sub-set of objects O1, O2; O2, O3; O3, O4 such that the sub-set of objects O1, O2; O2, O3; O3, O4 complies with the design rule. Design rules generally specify certain geometric and connectivity restrictions between objects O1, O2, O3, O4 of the integrated circuit to account for variability in manufacturing processes, for example, define a minimum distance between two objects O1, O2, or define a pitch between a plurality of objects O1, O2, O3, O4. Each manufacturing process typically has its own set of design rules. In a next step of the method according to the invention the circuit layout 100 is adapted to substantially comply with the set of constraints 304 during a step of adapting the layout 170. The method according to the invention subsequently checks if there are still off-grid reference elements in a step of objects off-grid 180. If there are still off-grid reference elements, the method according to the invention will be iteratively applied to the circuit layout 100. Before starting a next iteration step, the method according to the invention will fix the position of the previously gridded reference element (further indicated as fixed reference element feₙ) in a step of fixing previously gridded reference element 190. If there are no off-grid reference elements remaining, the method stops at a step end 200.

The step of adapting the layout according to constraints 170 generally comprises a step of solving set of constraints 172 in which the set of constraints 304 is solved and instructions are generated for adapting the circuit layout 100. Subsequently the objects O1, O2, O3, O4 of the circuit layout 100 are adapted according to the instructions. Known methods of solving the set of constraints are, for example, simplex algorithm or, for example, constraint graph longest path algorithm.

The effect of the method according to the invention is that the gridding problem of an off-grid reference element is described as a grid-constraint which is subsequently added to the set of constraints 304. The set of constraints 304 thus comprises both the design-rule-constraints to ensure that the objects comply with the design rules and the grid-constraint to ensure that the selected reference element seₙ is moved to the selected gridline sxᵢ, syᵢ. When adapting the circuit layout 100 to substantially comply with the set of constraints 304, the selected reference element seₙ is moved to the selected gridline sxᵢ, syᵢ while still the objects O1, O2, O3, O4 of the circuit layout 100 comply with the set of design rules 302 associated with the chosen manufacturing process.

The grid-constraint in the method according to the invention, for example, is expressed in a mathematical equation. When constraining the selected reference element seₙ to the selected gridline sxᵢ, the associated grid-constraint in the mathematical representation may be an equation such as:

seₙ=sxᵢ,

or alternatively, for example, the grid-constraint may comprise a set of equations, such as:

seₙ≦sxᵢ,

seₙ≧sxᵢ

In an embodiment of the method, the step of selecting a gridline 140 is replaced by a step of selecting a pair of gridlines 142, and the step of generating a grid-constraint 150 is replaced by a step of generating a disjunction-constraint 152. The pair of selected gridlines sxᵢ, syᵢ are generally located on opposite sides of the selected reference element seₙ, and are preferably sequential neighbours in the predefined grid. The disjunction-constraint constrains the selected reference element seₙ to either one of the selected gridlines sxᵢ, syᵢ, and is a representation of a required relationship between the selected reference element seₙ and each one of the selected pair of gridlines sxᵢ, syᵢ. The effect of the use of a disjunction-constraint is that it increases the possibility that the objects O1, O2, O3, O4 can be adapted to substantially comply with the set of constraints 304, because the selected reference element seₙ may be moved to either one of the selected pair of gridlines sxᵢ, syᵢ.

In an embodiment of the method according to the invention the method splits the disjunction-constraint into a first grid-constraint and a second grid-constraint during a step of splitting the disjunction constraint 174. The first grid-constraint constrains the selected reference element seₙ to a first gridline of the selected pair of gridlines sxᵢ, syᵢ, and the second grid-constraint constraints the selected reference element seₙ to a second gridline of the selected pair of gridlines sxᵢ, sy₁. The step of solving set of constraints 172 will solve the set of constraints 304 using only the first grid-constraint to generate instructions for adapting the circuit layout 100 to substantially comply with the set of constraints 304. If the circuit layout 100 can be adapted to substantially comply with the set of constraints 304 including the first grid-constraint, the second grid-constraints is disregarded and the method continues by checking if there are still off-grid reference elements in the step of objects off-grid 180. If no solution can be found using only the first grid-constraint, the step of solving set of constraints 172 subsequently will try to solve the set of constraints after replacing the first grid-constraint by the second grid-constraint.

Also the disjunction-constraints in the method according to the invention, for example, is expressed in a mathematical equation. When constraining the selected reference element seₙ to the pair of selected gridline sx₁, sx₂, the associated grid-constraint in the mathematical representation may be a set of equations, such as:

seₙ=sxᵢ [symbol] seₙ=sx₁,

or alternatively, for example, a set of equations, such as:

(seₙ≦sx₁ [symbol] seₙ≧sx₁), or

(seₙ≦sx₂ [symbol] seₙ≧sx₂)

In an embodiment of the method according to the invention, the step of finding off-grid reference elements 120 and the step of selecting off-grid reference element 130 are replaced by a step of scanning from an edge 122 during which step the method scans along a scan direction SD (see FIG. 6) which is defined by scanning from the edge of the circuit layout 100 away from the edge along a grid axis ga (see FIG. 6), by a step of selecting first off-grid reference element 124 during which step the first off-grid reference element along the scan direction is selected, and by a step of securing all (on-grid) reference elements between the edge and the selected reference element 126 during which step the location of all reference elements which are on grid and which are located between the edge and the selected reference element are secured. The effect of this embodiment is that the gridding is performed in an incremental manner in which, starting from the edge of the circuit layout 100, the reference elements unaligned to the grid are sequentially gridded in the scan-direction SD. Because the reference elements which have already been aligned to the grid in a previous iteration step are secured before the next non-gridded reference element is aligned to the grid, the compliance of the circuit layout 100 to the grid increases with every iteration step.

Alternatively the step of selecting a gridline 140 comprises selecting a pair of intersecting gridlines sxᵢ, syᵢ, defining a grid-point. The step of generating grid-constraint 150 comprises generating a grid-point-constraint constraining the selected reference element seₙ to the pair of intersecting gridlines sxᵢ, syᵢ. The grid-point-constraint represents a required relationship between the selected reference element seₙ and the selected grid-point.

FIG. 2 shows a schematic representation of the system 300 according to the invention. The system 300 is configured for adapting a circuit layout 100 to the predefined grid by adapting the circuit layout 100 to substantially comply with a set of constraints 304. The system 300 comprises a scanner module 310 receiving the circuit layout 100 and scanning the circuit layout 100 to identify objects O1, O2, O3, O4 and identify the elements be_{n,m}, pe_{n,m}, ce_{n,m}, and reference elements of each object O1, O2, O3, O4. Generally, the system 300 comprises a memory module 305 which is used for storing data and in which the scanner module 310, for example, stores the identified elements and reference elements. The system 300 further comprises an element selector 320 and a gridline selector 360. The element selector 320 selects from the identified reference elements the selected reference element seₙ being an off-grid reference element which must be gridded by the system 300. The gridline selector 360 selects a gridline xᵢ, yᵢ, from the predefined grid on which the selected reference element seₙ must be gridded. A constraint generator 330 receives the selected reference element seₙ and the selected gridline sxᵢ, syᵢ and generates a grid-constraint constraining the selected reference element seₙ to the selected gridline sxᵢ, syᵢ. The grid-constraint is a representation of a required relationship between the selected reference element seₙ and the selected gridline sxᵢ, syᵢ. The system 300 further comprises a constraint adder 340 which adds the grid-constraint to the set of constraints 304 associated with the circuit layout 100. The set of constraints 304 comprises design-rule-constraints being a representation of the applying of a design rule to a sub-set O1, O2; O2, O3; O3, O4 of objects of the circuit layout 100. Subsequently the layout adapter module 350 adapts the objects O1, O2, O3, O4 of the circuit layout 100 to obtain an output 102 being a circuit layout substantially complying with the set of constraints.

In an embodiment of the layout adapter module 350, the layout adapter module may include a solver module 355 for solving the set of constraints and generate instructions for adapting the circuit layout 100 such that the circuit layout 100 adapted according to the instruction substantially complies with the set of constraints. The solver module 355 may use well known methods for solving the set of constraints, for example, simplex algorithm or, for example, constraint graph longest path algorithm.

Alternatively, the solver module 355 is a separate module (not shown) of the system 300 which provides the instructions for adapting the circuit layout 100 to the layout adapter module 350 which subsequently adapts the circuit layout 100 according to the instructions.

In an embodiment of the system 300, the system 300 is integrated in a known layout processing system (not shown). In this embodiment, the system 300 may share the scanner module 310, the solver module 355 and the layout adapter module 360 with the known layout processing system.

In an embodiment of the constraint generator 330, the constraint generator 330 is arranged to change the grid-constraint of a gridded reference element into a priority-constraint or to apply the priority-constraint to a reference element already on grid. The priority-constraint secures the location of the gridded reference element. This may, for example, be used when using the system 300 iteratively whereby the system 300 fixed the position of the reference element gridded during a previous iteration. Alternatively the priority-constraint may, for example, be used when scanning the circuit layout 100 from an edge of the circuit layout 100 to find the first off-grid reference element being the selected reference element seₙ. All reference elements which are located on grid and which are located between the edge of the circuit layout 100 and the selected reference element seₙ are, for example, fixed by applying a priority-constraint for each of these on-grid reference elements. The priority-constraint may, for example, comprise a priority-value representing a level of importance of the required fixation of the gridded reference element. The priority-value may vary for different reference elements to, for example, generate different levels of fixation and as such represent the required fixation in different levels of fixation of the gridded reference element. The different levels of fixation, for example, depend on the importance of the fixation of the reference element to the gridded position. The fixation of the reference elements having a relatively high priority-value, for example, has priority over the fixation of the reference elements having a relatively low priority-value. This increases the flexibility for the solver module 355 to find a solution to the set of constraint such that the selected reference element seₙ can be gridded while the objects of the circuit layout 100 substantially comply with the design rules 302.

In an embodiment of the gridline selector 360, the gridline selector 360 is arranged to select a pair of gridlines sxᵢ, syᵢ. The pair of selected gridlines sxᵢ, syᵢ may, for example, be located on opposite sides of the selected reference element seₙ, and may, for example, be sequential neighbours in the predefined grid. Alternatively the pair of selected gridlines sxi, syi may, for example, be intersecting gridlines xᵢ, yᵢ defining a grid-point.

In an embodiment of the constraint generator 330, the constraint generator 330 is arranged to generate the disjunction-constraint for constraining the selected reference element seₙ to either one of the pair of selected gridlines sxi, syi. Alternatively, the constraint generator 330 may split the disjunction-constraint into a first and a second grid-constraint. The first grid-constraint constrains the selected reference element seₙ to a first gridline of the selected pair of gridlines sxᵢ, syᵢ and the second grid-constraint constraining the selected reference element seₙ to a second gridline of the selected pair of gridlines sxᵢ, syᵢ.

FIGS. 3A, 3B, 3C and 3D show several steps performed by the method according to the invention when gridding two objects O1, O2 of the circuit layout 100. FIG. 3A shows the two objects O1, O2 which comprise elements be_{n,m}. The object O1, O2 are polygons (in this example rectangular shaped objects O1, O2) which are defined by the edges of the polygons, the so called boundaries be_{n,m} of the polygon. In the example shown in FIG. 3 the most left vertical boundary is chosen to be the reference element be_{n,1}. However, any other boundary be_{n,m} of the objects O1, O2 may be chosen as the reference element, whereby preferably a boundary be_{n,m} at a same predetermined edge of each of the objects O1, O2 should be chosen. The predefined grid xᵢ to which the objects O1, O2 should be aligned is a one-dimensional grid constituted of equidistant gridlines xᵢ of which FIG. 3A shows four gridlines x₁, x₂, x₃, x₄ being sequential neighbours in the predefined grid xᵢ. As can be seen from FIG. 3A both reference elements be_{1,1}, be_{2,1} are not located on any of the four gridlines x₁, x₂, x₃, x₄.

FIG. 3B shows a further step of the method according to the invention. The references numerals of the boundaries be_{n,m} of the two objects O1, O2 have been omitted for clarity reasons. Now, the reference element be_{1,1} has been selected to be the selected reference element se₁ (indicated in FIG. 3B with a dashed bold line at the boundary be_{1,1}) and the second gridline x₂ has been selected (indicated in FIG. 3B by a bold gridline sx₂) to be the selected gridline sx₂. The method will generate a grid-constraint which will move the selected reference element se₁ to coincide with the selected gridline sx₂, generally in a direction of an arrow indicated with ΔO₁. Depending on the set of design-rules 302 (see FIG. 2) the moving of the selected reference element se₁ may result in moving the object O1 or reshaping the object O1.

FIG. 3C shows a step of the method in which the selected reference element se₁ of FIG. 3B has been moved to the selected gridline sx₂. Furthermore, the location of the gridded reference element se₁ has been fixed to be a fixed reference element fe₁, for example, by replacing the grid-constraint by a priority-constraint. The fixation of the fixed reference element fe₁ is indicated in FIG. 3C with a bold line at the location of the fixed reference element fe₁. Subsequently, the method is applied iteratively to the two objects O1, O2 and the reference element be_{2,1} (see FIG. 3A) is the further reference element which is unaligned to the grid and which is selected as a further selected reference element se₂ in the iteration step. The third gridline x₃ has been selected to be a further selected gridline sx₃ in the iteration step. The method will generate a grid-constraint which will move the further selected reference element se₂ to the further selected gridline sx₃, for example by moving the further selected reference element se2 generally in a direction of an arrow indicated with ΔO₂.

FIG. 3D shows the two objects O1, O2 of the circuit layout 100 after the iteratively applying the method. Now, both reference elements be_{1,1} and be_{2,1} (see FIG. 3A) coincide with the second and third gridline x₂, x₃, respectively. Now also the location of the further selected reference element se₂ has been fixed to be a further fixed reference element fe₂, for example, by replacing the grid-constraint by a priority-constraint.

FIGS. 4A and 4B show steps of the method when the reference element is a path pe_{n,m}. When the object O1, O2 is defined by a path the elements defining the object O1, O2 typically comprise of a path pe_{n,1}, or centerline pe_{n,1} together with a width pe_{n,2} of the object O1, O2. Generally, the path pe_{n,1} or centerline pe_{n,1} of the object is used as the reference element pe_{n,1}. FIG. 4A shows a step of the method which is equivalent to the step shown in FIG. 3B. In FIG. 4A the selected reference element se₁ being the centerline pe_{1,1}, and the selected gridline sx₂ are indicated by bold dashed lines. The method will generate a grid-constraint which will move the selected reference element se₁ to coincide with the selected gridline sx₂.

FIG. 4B shows a step of the method which is equivalent to the step shown in FIG. 3C. In FIG. 4B the selected reference element se₁ of FIG. 4A has been moved to the selected gridline sx₂. Furthermore, the location of the gridded reference element se₁ has been fixed to be a fixed reference element fe₁ (the fixation of the fixed reference element fe₁ is again indicated with a bold line at the location of the fixed reference element fe₁). Subsequently, the method is applied iteratively to the two objects O1, O2 and the reference element pe_{2,1} (see FIG. 4A) is the further reference element which is unaligned to the grid which is selected as a further selected reference element se₂ in the iteration step. The third gridline x₃ has been selected to be a further selected gridline sx₃ in the iteration step. The method will generate a grid-constraint which will move the further selected reference element se₂ to the further selected gridline sx₃.

FIGS. 5A and 5B show steps of the method when the reference element is a corner ce_{n,m}. In the example shown in FIG. 5 the upper left corner c_{n,1} is chosen to be the reference element ce_{n,1}. However, any other corner ce_{n,m} of the objects O1, O2 may be chosen as the reference element, whereby preferably for each of the objects O1, O2 a same predetermined corner ce_{n,m} should be chosen. In the embodiment shown in FIG. 5, the predefined grid is a two-dimensional grid constituted by orthogonal equidistant gridlines xᵢ, yᵢ. FIG. 5A shows a step of the method which is equivalent to the step shown in FIG. 3B. In FIG. 5A the selected reference element se₁ is the upper left corner ce_{1,1}, and the selected grid point is defined by two intersecting selected gridlines sx₂, sy₂, which are indicated by bold dashed lines. The method will generate a grid-constraint which will move the selected reference element se₁ to coincide with the selected grid point.

FIG. 5B shows a step of the method which is equivalent to the step shown in FIG. 3C. In FIG. 5B the selected reference element se₁ of FIG. 5A has been moved to the selected grid point. Furthermore, the location of the gridded reference element se₁ has been fixed to be a fixed reference element fe₁. Subsequently, the method is applied iteratively to the two objects O1, O2 and the reference element ce_{2,1} (see FIG. 5A) is the further reference element which is unaligned to the grid which is selected as a further selected reference element se₂ in the iteration step. A further pair of intersecting gridlines x₃, y₃ has been selected for defining the further selected grid point. The method will generate a grid-constraint which will move the further selected reference element se₂ to the further selected grid point.

FIGS. 6A, 6B and 6C show several steps in the method for gridding a plurality of objects O1, O2, O3, O4 forming a grating. FIG. 6 shows part of a footprint FP, being an area occupied by the circuit layout. The part of the footprint FP shown FIG. 6 contains two unused areas, so called redundant areas indicated with RA₁ and RA₂. The plurality of objects O1, O2, O3, O4 partially form a grating of which a pitch of the grating is substantially equal to the distance between the gridlines of the predefined grid. The plurality of objects O1, O2, O3, O4 are defined by boundaries (not indicated) of which a left vertical edge of each object O1, O2, O3, O4 is chosen to be the reference element of each object O1, O2, O3, O4 (identical to the objects of FIG. 3). In FIG. 6 also the scan direction SD is indicated with a bold arrow labeled SD. The method according to the invention scans the objects O1, O2, O3, O4 from the edge of the footprint FP away from the edge of the footprint FP along the grid axis (indicated with an arrow labeled ga). FIG. 6A shows a step of the method which is equivalent to the step shown in FIG. 3B. In FIG. 6A the selected reference element se₁ and the selected gridlines sx₁, sx₂ are indicated by bold dashed lines. However, now a pair of gridlines sx₁, sx₂ is selected located on opposite sides of the selected reference element se₁. The method will generate a disjunction-constraint which will constrain the selected reference element se₁ to either one of the selected gridlines sx₁, sx₂. Because of the two redundant areas, the layout adapter 350 (see FIG. 2) may use either of the two redundant areas when adapting the circuit layout 100 to substantially comply with the set of constraints, which now also includes the disjunction-constraint. So the selected reference element se₁ can be moved to either one of the selected gridlines indicated with the arrows labeled ΔO_{1,1}, ΔO_{1,2}.

FIG. 6B shows a step of the method which is equivalent to the step shown in FIG. 3C when the selected reference element se₁ is moved in the direction of the arrow labeled ΔO_{1,1}. In FIG. 6B the selected reference element se₁ has been moved to the selected gridline sx₁ and the location of the gridded reference element se₁ has been fixed to be a fixed reference element fe_{1,1}, for example, by replacing the grid-constraint by a priority-constraint. The fixation of the fixed reference element fe_{1,1} is indicated in FIG. 6B with a bold line at the location of the fixed reference element fe_{1,1}. Subsequently, the method is applied iteratively to the set of objects O1, O2, O3, O4 and the further reference element which is unaligned to the grid and which is selected as the further selected reference element se₂. A further pair of gridlines sx₂, sx₃ is selected located on opposite sides of the further selected reference element se₂ and the method will generate a further disjunction-constraint constraining the further selected reference element se₂ to either one of the further selected gridlines sx₂, sx₃. After adding the further disjunction-constraint to the set of constraints, the layout adapter 350 adapts the circuit layout 100 to substantially comply with the set of constraints, which now includes the priority-constraint and the further disjunction-constraint.

FIG. 6C shows a step of the method which is equivalent to the step shown in FIG. 3C when the selected reference element se₁ is moved in the direction of the arrow labeled ΔO_{1,2}. In FIG. 6C the selected reference element se₁ has been moved to the selected gridline sx₂ and the location of the gridded reference element se₁ has been fixed to be a fixed reference element fe_{1,2}, for example, by replacing the grid-constraint by a priority-constraint. The fixation of the fixed reference element fe_{1,2} is indicated in FIG. 6B with a bold line at the location of the fixed reference element fe_{1,2}. The main difference between the gridding solution shown in FIG. 6B and the gridding solution shown in FIG. 6C is that the layout adapter module 350 has used the design rules associated with the circuit layout 100 to be able to use the redundant area indicated with RA₂ (see FIG. 6A). When the selected reference element se1 is simply moved in the direction of the arrow labeled ΔO_{1,2} to coincide with the selected gridline sx₂, the width of the object O1 associated with the selected reference element se1 will change and the distance between two neighboring objects O1, O2 will change. Alternatively, when moving the object O1 to coincide with the selected gridline sx₂, the object O1 will overlap a further object O1, O2, O3, O4 of the set of objects O1, O2, O3, O4. This is generally not allowed and is typically forbidden by the design rules associated with the circuit layout 100. The only way for the layout adapter module 350 to use the redundant area indicated with RA2 is to also shift the plurality of objects O1, O2, O3, O4 in the direction of the arrow labeled ΔO_{1,2}. A benefit of the use of the redundant area indicted with RA2 is that not only the selected reference element se1 is aligned to the predefined grid, but all reference elements of the plurality of objects O1, O2, O3, O4 have been aligned to the grid at the same time. The reason for this substantial automatic alignment of the reference elements to the predefined grid is that the design rules generally fit on the predefined grid. For example, the minimum pitch between objects O1, O2, O3, O4 in a grating of objects O1, O2, O3, O4 is equal to the distance between two sequential gridlines xₙ. When the design rule associated with the grating of objects O1, O2, O3, O4 determines that the grating of objects O1, O2, O3, O4 should be on the minimum pitch, the move of the selected reference element in the direction of the arrow labeled ΔO_{1,2} results in the move of the grating of objects O1, O2, O3, O4 while maintaining the grating of objects O1, O2, O3, O4 on the required minimum pitch. This automatically aligns all reference elements of the objects O1, O2, O3, O4 of the grating of objects O1, O2, O3, O4. So when moving the selected reference element se1 in a direction parallel to the scan direction SD other reference elements may automatically align to the predefined grid, which results in a substantial reduction of the time required to align all reference elements to the predefined grid. In FIG. 6C the location of the gridded reference elements has been fixed to be a fixed reference element fe_{1,2}, fe₂, fe₃ fe₄. Subsequently, the method is applied iteratively to the circuit layout 100 and a further reference element (not shown) is searched along the scan direction SD which is unaligned to the predefined grid.

It should be noted that the above-mentioned embodiments illustrate rather than limit the invention, and that those skilled in the art will be able to design many alternative embodiments without departing from the scope of the appended claims.

Any reference to objects in layouts such as in the integrated circuit or the circuit layout may refer to polygons being defined by boundaries, paths or corners.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method for adapting a circuit layout to a predefined grid, the circuit layout comprising objects being a representation of an integrated circuit, each object being defined by elements including a reference element, the method comprising the steps of:
selecting a reference element being unaligned to the predefined grid,
selecting a gridline from the predefined grid,
generating a grid-constraint for constraining the selected reference element to the selected gridline, the grid-constraint being a representation of a required relationship between the selected reference element and the selected gridline,
adding the grid-constraint to a set of constraints associated with the circuit layout, the set of constraints comprising design-rule-constraints for applying a design rule to groups of objects of the circuit layout, and
adapting the objects of the circuit layout to substantially comply with the set of constraints, wherein the steps of the method are applied iteratively by in each iteration selecting a further reference element being unaligned to the predefined grid.

2. (canceled)

3. The method as claimed in claim 1, wherein the method further comprises a step of:
securing a location of the reference element gridded in a previous iteration before adapting the objects of the circuit layout by replacing the grid-constraint of the gridded reference element in the set of constraints by a priority-constraint for securing the location of the gridded reference element, the priority-constraint being a representation of a required fixation of the gridded reference element to the selected gridline.

4. The method as claimed in claim 3, wherein the priority-constraint comprises a priority-value representing a level of importance of the required fixation of the gridded reference element.

5. The method as claimed in claim 1, the step of selecting a gridline comprises selecting a pair of gridlines arranged on opposite sides of the selected reference element or the selected further reference element, wherein the grid-constraint associated with the selected reference element or the selected further reference element comprises a disjunction-constraint for constraining the selected reference element or the selected further reference element to either one of the gridlines in the selected pair of gridlines.

6. The method as claimed in claim 5, the step of adapting the objects of the circuit layout comprising solving the set of constraints to generate instructions for adapting the circuit layout, wherein the method further comprises a step of:
splitting the disjunction-constraint in a first and a second grid-constraint, and solving the set of constraints using the first grid-constraint, the first grid-constraint constraining the selected reference element to a first gridline of the selected pair of gridlines and the second grid-constraint constraining the selected reference element to a second gridline of the selected pair of gridlines,
and wherein the second grid-constraint is only used for solving the set of constraints when the set of constraints cannot be solved using the first grid-constraint.

7. The method as claimed in claim 1, the step of selecting a gridline comprises selecting a pair of intersecting gridlines defining a grid-point, wherein the step of generating a grid-constraint comprises generating a grid-point-constraint constraining the selected reference element or the selected further reference element to the selected pair of intersecting gridlines.

8. The method as claimed in claim 1, wherein the step of selecting the reference element or the further reference element comprises scanning the circuit layout in a scan-direction defined by scanning from an edge of the circuit layout away from the edge along a grid axis and selecting a first reference element or a first further reference element from the edge being unaligned to the predefined grid.

9. The method as claimed in claim 8, wherein the method further comprises a step of:
securing all reference elements being aligned to the predefined grid and being located between the edge of the circuit layout and the selected reference element or the selected further reference element along the scan-direction before performing the step of adapting the objects of the circuit layout to substantially comply with the set of constraints.

10. A system configured for adapting an circuit layout to a predefined grid, the circuit layout comprising objects being a representation of an integrated circuit, each object being defined by elements including a reference element, the system comprising:
an element selector configured for selecting a reference element,
a grid-line selector configured for selecting a gridline from the predefined grid,
a constraint generator configured for generating a grid-constraint for constraining the selected reference element to the selected gridline, the grid-constraint being a representation of a required relationship between the selected reference element and the selected gridline,
a constraint adder configured for adding the grid-constraint to a set of constraints associated with the circuit layout, the set of constraints comprising design-rule-constraints for applying a design rule to groups of objects of the circuit layout,
a layout adapter configured for adapting the objects of the circuit layout to substantially comply with the set of constraints.

11. A computer program product arranged to perform the method as claimed in claim 1.

12. The method as claimed in claim 3, wherein the step of selecting the reference element or the further reference element comprises scanning the circuit layout in a scan-direction defined by scanning from an edge of the circuit layout away from the edge along a grid axis and selecting a first reference element or a first further reference element from the edge being unaligned to the predefined grid.
